(19) United States
(12) Patent Application Publication
(10) Pub. No.: US 2019/0329122 A1
(43) Pub. Date: Oct. 31, 2019

(54) Skateboard Foot Pedal Mechanism

(71) Applicants: Bernard Lee, New Hyde Park, NY (US); Seldon Price, Logansport, IN (US); Drew Philip Haywood, Bloomfield, IN (US)

(72) Inventors: Bernard Lee, New Hyde Park, NY (US); Seldon Price, Logansport, IN (US); Drew Philip Haywood, Bloomfield, IN (US)

(21) Appl. No.: 15/963,002

(22) Filed: Apr. 25, 2018

(51) Int. Cl. A63C 17/12; F16H 31/00; F16H 19/04

(52) U.S. Cl. CPC A63C 17/12; F16H 19/04; F16H 31/001

(57) ABSTRACT

A manually operated propelling method for skateboard or longboard skating comprising of an attachable foot pedal mechanism. The mechanism translates linear motion from the user to rotational motion at the wheel of the skateboard. This mechanism allows the rider to propel the skateboard forward without having to remove a foot from the skateboard deck. This is achieved by pushing a spring loaded pedal mounted on the board, which moves a bracket containing a unidirectional ratchet styled gear, which then drives a driving gear that is clamped to the one of the skateboard trucks, which in turn interacts with a driven gear attached to one or more wheels of the skateboard.

### FIELD OF THE INVENTION

The present disclosure generally relates to an apparatus which transfers energy from a manually operated mechanism to a wheel or wheels on a skateboard. In particular, to an apparatus which can transfer translational energy from a foot pedal to a gear train, and from the gear train to a driving wheel.

### BACKGROUND OF THE INVENTION

This section introduces aspects that may help facilitate a better understanding of the disclosure. Accordingly, these statements are to be read in this light and are not to be understood as admissions about what is or is not prior art.

Skateboards are old and well known in the art. The common way to propel a skateboard is to kick the ground with one foot while the other remains stationary on the board. Even on flat ground, enough energy is lost due to friction between the wheels and the ground that the user is required to kick the ground repeatedly to propel the skateboard. This causes a moment of imbalance, as the user has to momentarily support their weight on one foot in order to kick the ground, thus increasing the risk of injury.

A common alternative to constantly kick the ground to propel the skateboard is to use an electric motor powered skateboard. The electric motor powers the wheels of the skateboard, drawing power from a battery, which propels the skateboard, freeing the user from kicking the ground as a means to propel the skateboard. This technology is expensive to purchase and, with the electric motor needing to be recharged, is not always able to be used if the battery depletes its electrical charge.

U.S. Pat. No. 8,465,056 to Weir et al. discloses a longboard skating propulsion pole which is used by pushing the ground with the pole using your arms.

U.S. Pat. No. 7,192,038 to Tsai discloses a foot propelled scooter where the primary way of propelling the scooter is with two foot pedals.

Therefore, there is an unmet need for a more affordable approach to eliminating the constant need to kick in order to propel the board forward to overcome the small amount of friction between the wheels and ground. Thus there is a need to provide a system for propelling the skateboard forward without having to remove one foot from the board to kick.

### SUMMARY

An apparatus which is a system that transfers manual input from a foot pedal on the board moved by a foot of the user to one or more wheels on a skateboard.

Accordingly, it is an objective of the present invention to provide a system that converts the linear motion from the foot pedal into rotational motion for a wheel of the skateboard.

It is a further objective of the present invention to allow the skateboard user to avoid removing one foot from the board to consistently kick the ground to propel the board on a flat surface to overcome the friction between the wheels and ground.

### BRIEF DESCRIPTION OF DRAWINGS

FIG. 1 is a perspective partial front view of the present invention mounted to skateboard truck

FIG. 2 is a perspective partial front view of the gear train

FIG. 3 is a perspective partial rear view of the spring loaded foot lever and mounting plate

FIG. 4 is a perspective partial front view of the bracket and spring hooks

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

Those having ordinary skill in the art will recognize that numerous modifications can be made to the specific implementations described above. The implementations should not be limited to the particular limitations described. Other implementations may be possible.

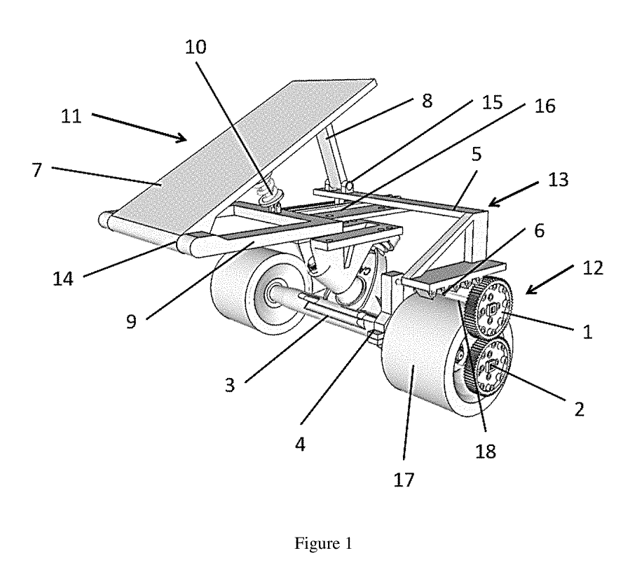

Now referring to the figures, illustrated in FIG. 1 is a preferred embodiment of a foot propulsion mechanism comprising a spring loaded lever and mounting plate assembly 11, truck mounted gear train 12, and sliding bracket assembly 13. The mounting plate assembly 11 is secured to the skateboard deck and the truck mounted gear train 12 is secured to the skateboard truck 3. When the foot lever 7 is pushed, translational energy is transferred to the bracket 5. The spring 10 pushes the foot lever 7 up once the energy is transferred to the bracket 5. The pivot arm 8 keeps the bracket 5 to a single direction of motion, which avoids the spring hooks 6 from losing contact with the driving gear 1. The hinge 15 attaches the pivot arm 8 and bracket 5. The spring hooks 6 contact with the driving gear 1 is where the translation energy from the foot lever converts into rotational motion. The driving gear 1 transfers energy to the driven gear 2. The driving gear 1 is attached to the driving gear clamp 4 through an axle 18. The driven gear 2 is attached to wheel 17.

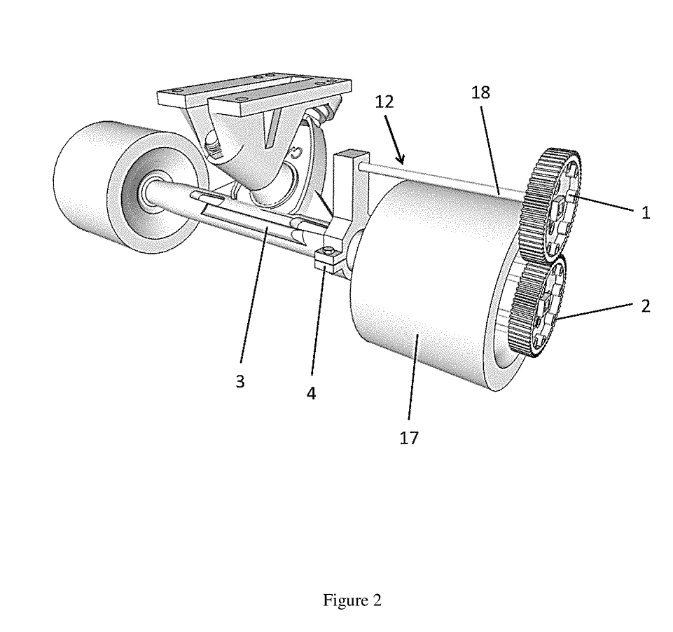

Illustrated in FIG. 2, the truck mounted gear train 12 consists of a driving gear 1, a driven gear 2, the skateboard truck 3, and the driving gear clamp 4. The driving gear 1 is attached to the driving gear clamp 4 through an axle 18. The driven gear 2 is attached to wheel 17. The translational energy from the mounting plate assembly 11 is transferred to the driven gear 2 from the driving gear 1 through the sliding bracket assembly 13. The actuating motion from foot lever 7 pushes the sliding bracket assembly 13 through the pivot arm 8. Once the actuating motion is complete, the user can release the pressure on foot lever 7 in preparation for the next actuating motion. The driving gear clamp 4 secures the driving gear 1 to the system by attaching to the skateboard truck 3.

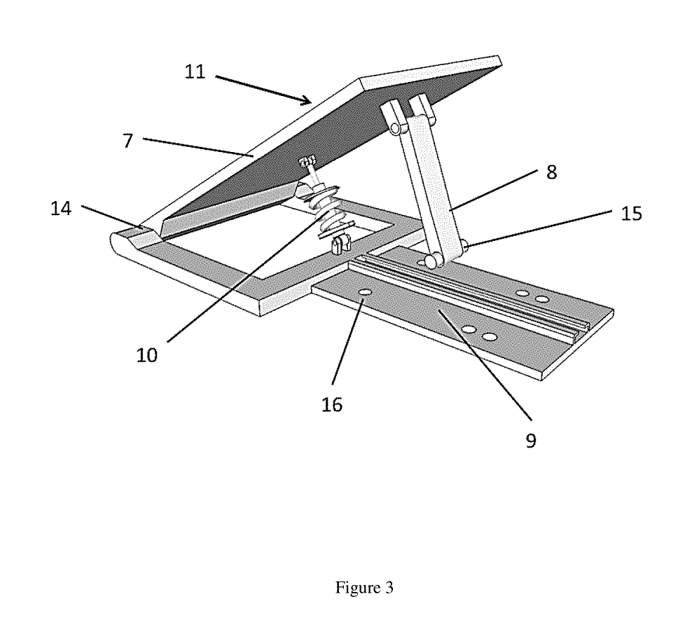

Illustrated in FIG. 3, the mounting plate assembly 11 consists of a mounting plate 9, foot lever 7, spring 10, and pivot arm 8. The mounting plate 9 incorporates holes that are of the same dimensions as standard mounting dimensions of skateboard trucks, and therefore are secured to the skateboard through the use of screws through screw holes 16. The foot lever 7 is attached to the mounting plate 9 through a lever hinge 14 and through the pivot arm 8 and the spring 10. The spring 10 keeps the foot lever 7 in its upright position when the user is not depressing the foot lever 7. The pivot arm 8 is attached to both the foot lever 7 and the sliding bracket assembly 13 through a hinge 15 on each end.

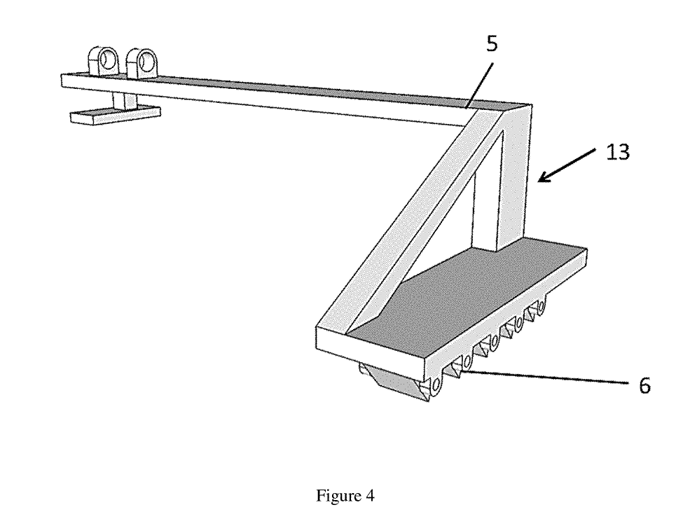

FIG. 4 represents the sliding bracket assembly 13 that ultimately transfers the input energy from the foot lever 7 and pivot arm 8 to a wheel on the skateboard. The bracket 5 is attached to the pivot arm 8 by a hinge 15. When foot lever 7 is depressed, the pivot arm 8 pushes sliding bracket assembly 13 in a sliding action in the direction opposite to the direction of travel. The sliding action forces the spring hooks 6 to engage the driving gear 1, causing the driving gear 1 to rotate. The spring hooks 6 are unidirectional pivoting hooks that use springs to set their default position. This allows the spring hooks 6 to propel the driving gear 1. When the foot lever 7 is fully depressed, the spring hooks 6 will not impede the rotation of the driving gear 1. This ensures the device is able to propel forward without stopping or slowing down, allowing the user to coast.

What is claimed is:

1. An attachable human-powered propulsion apparatus for any type of skateboard comprising:
A method for a user to accelerate forward without removing feet from the vehicle.
A foot supporting pedal that attaches to the top surface of the vehicle
A power-transmission response for causing at least one of said wheels to spin as a result of the depression of one's foot
A pivoting means for said foot pedal that allows a long lever arm to have an optimal angular deviation during a pedal stroke
A method of returning the pedal to an upright position after foot depression.

2. The vehicle of claim 1 wherein said human-powered propulsion apparatus comprises of a mounting plate secured to the skateboard deck and skateboard truck by sharing the use of the skateboard truck fasteners.

3. The vehicle of claim 1 wherein said apparatus can be installed on any existing skateboard that belongs to the user or is available for purchase.

4. The vehicle of claim 1 wherein said foot supporting pedal contains a supporting arm and horizontal pivot to transfer downward energy to horizontal forward and backwards motion

5. The vehicle of claim 1 wherein the pedal-returning method comprises of a spring apparatus.

6. The vehicle of claim 1 wherein the downward force of the foot pedal spins a driving gear by means of a unidirectional gear train apparatus.

7. The driving gear of claim 6 wherein the gear spins freely and is mounted to a solid member that is statically secured to the solid truck axle of the skateboard.

8. The driving gear of claim 6 wherein there is a driven gear statically secured and not able to spin independently to the roller wheel of the skateboard.

9. The statically secured solid member of claim 7 wherein a collar-style clamp is used to secure the solid member to the solid truck axle of the skateboard.

10. The foot pedal of claim 1, the spring apparatus of claim 5, and the unidirectional gear train apparatus of claim 6 are secured by the mounting plate of claim 2.

11. The unidirectional gear train apparatus of claim 6 wherein the gear train spins the driving gear counterclockwise to the frontward direction of the skateboard. The gear train is keyed to only allow propulsion of the driving wheel in the counterclockwise direction and does not interfere or cause the driving wheel to spin clockwise.
